(19) United States
(12) Patent Application Publication
(10) Pub. No.: US 2011/0051179 A1
(43) Pub. Date: Mar. 3, 2011

(54) FACSIMILE DEVICE, IMAGE FORMING DEVICE, COMMUNICATION SYSTEM, COMMUNICATION METHOD AND PROGRAM STORAGE MEDIUM

(75) Inventor: Toshihiro IGA, Ebina-shi (JP)

(73) Assignee: FUJI XEROX CO., LTD., Tokyo (JP)

(21) Appl. No.: 12/717,178

(22) Filed: Mar. 4, 2010

(30) Foreign Application Priority Data
Aug. 25, 2009 (JP) 2009-194247

(51) Int. Cl. G06F 15/00; H04N 1/32

(52) U.S. Cl. 358/1.15; 358/442

(57) ABSTRACT

A facsimile device includes a transmitting unit, a receiving unit, an obtaining unit, and a controller. The transmitting unit transmits, when receiving a transmission instruction of image data while a communication state is established with a first destination of the image data, the image data to the first destination. The receiving unit receives, from the first destination, first destination information indicating the first destination. The obtaining unit obtains second destination information indicating a destination of the image data from the image data. The controller controls the transmitting unit so as not to transmit the image data when the first destination indicated by the first destination information and the second destination indicated by the second destination information are different from each other.

### CROSS-REFERENCE TO RELATED APPLICATIONS

This application is based on and claims priority under 35 USC 119 from Japanese Patent Application No. 2009-194247 filed on Aug. 25, 2009.

### BACKGROUND

1. Technical Field

The present invention relates to a facsimile device, an image forming device, a communication system, a communication method and a computer readable storage medium storing a communication program.

2. Related Art

A data transmission method has been proposed that includes an inputting step of destination information, a determination step of comparing the input destination information with transmission history information including destination information of which transmission has been already finished successfully to determine correctness of the destination information, and a transmission step of, when the destination information is determined to be correct, transmitting transmission data to a destination specified by the destination information via communication network.

A facsimile device has been also proposed that includes a document reading unit that reads a document, a destination input unit that inputs or specifies first destination information, and a transmission unit that transmits data obtained by the document reading unit via a communication line. The facsimile device further includes a destination identification unit that identifies second destination information from the data obtained by the document reading unit, a destination comparing unit that compares the first destination information with the second destination information, and a notification unit that sends a warning when the comparison of the destination comparing unit results in mismatch.

### SUMMARY

An aspect of the present invention is a facsimile device including: a transmitting unit that, when receiving a transmission instruction of image data while a communication state is established with a first destination of the image data, transmits the image data to the first destination; a receiving unit that receives, from the first destination, first destination information indicating the first destination; an obtaining unit that obtains second destination information indicating a destination of the image data from the image data; and a controller that controls the transmitting unit so as not to transmit the image data when the first destination indicated by the first destination information and the second destination indicated by the second destination information are different from each other.

### BRIEF DESCRIPTION OF THE DRAWINGS

Exemplary embodiments of the present invention will be described in detail based on the following figures, wherein:

FIG. 1 is a block diagram illustrating a structure of a communication system according to exemplary embodiments;

FIG. 2 is a perspective view illustrating a principal part of an image forming device according to the exemplary embodiments;

FIG. 3 is a block diagram illustrating the structure of a principal part of the electric system of the image forming device according to the exemplary embodiments;

FIG. 4 is a block diagram illustrating the structure of the principal part of the electric system of a facsimile device according to the exemplary embodiments;

FIG. 5 is a functional block diagram illustrating the functional structure of the image forming device according to the exemplary embodiments;

FIG. 6 illustrates the structure of a document according to the exemplary embodiments;

FIG. 7 is a flowchart showing a processing of an image transmission program according to a first exemplary embodiment;

FIG. 8 is a flowchart showing a processing of a transmission stop routine program according to the first and second exemplary embodiments;

FIG. 9 illustrates the structure of a receiving operation instruction screen according to the exemplary embodiments;

FIG. 10 illustrates the structure of a transmitting operation instruction screen according to the first and third exemplary embodiments;

FIG. 11 illustrates the structure of a check instruction screen according to the first and second exemplary embodiments;

FIG. 12 is a diagrammatic view for explanation of processing flow in the communication system according to the exemplary embodiments;

FIG. 13 is a diagram illustrating the data structure of a transmission document correspondence database according to the second exemplary embodiment;

FIG. 14 is a flowchart illustrating a processing of the image transmission program according to the second exemplary embodiment;

FIG. 15 illustrates the structure of a document selection screen according to the second exemplary embodiment;

FIG. 16 is a flowchart illustrating a processing of the image transmission program according to the third exemplary embodiment;

FIG. 17 is a flowchart showing a processing of the transmission check routine program according to the third exemplary embodiment; and

FIG. 18 illustrates the structure of the transmission check (confirmation) screen according to the third exemplary embodiment.

### DETAILED DESCRIPTION

### First Exemplary Embodiment

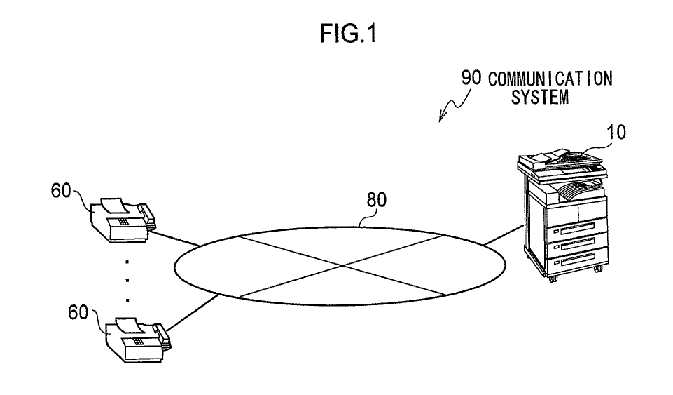

FIG. 1 illustrates the structure of a communication system 90 according to an exemplary embodiment. As illustrated in FIG. 1, the communication system 90 has an image forming device 10 as a facsimile device according to the exemplary embodiment and plural other facsimile devices 60. The image forming device 10 is connected to each of the facsimile devices 60 via a telephone line 80 and the image forming device 10 and each facsimile device 60 perform transmission and reception of various data via the telephone line 80.

The communication system 90 provides a predetermined user with a service of transmitting image data representing an image of a document which is predetermined in response to a request from the user (this service is hereinafter referred to as “image transmission service”). Each facsimile device 60 is owned by each user of the service and the image forming device 10 is owned by an image transmission service provider.

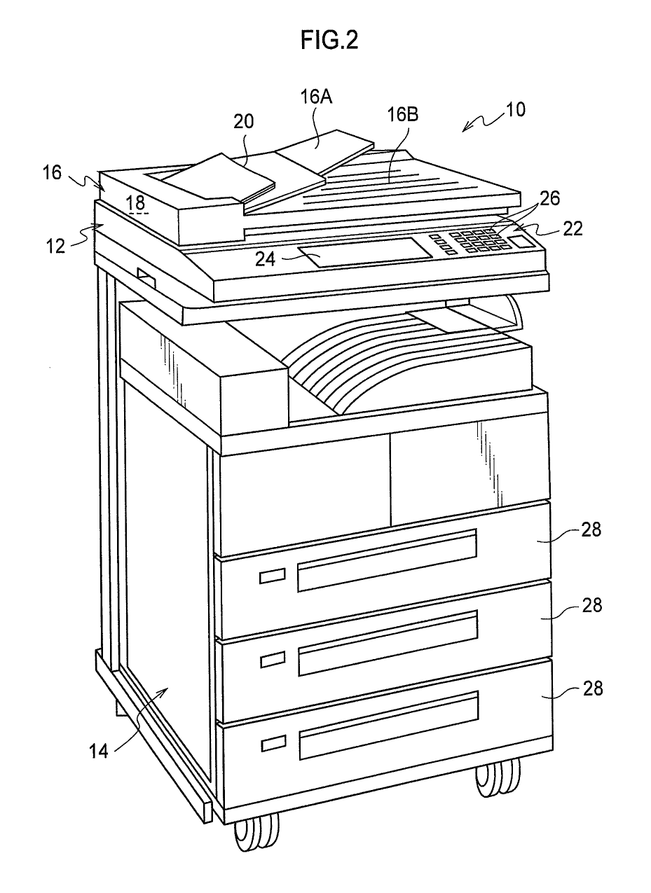

FIG. 2 illustrates the structure of the image forming device 10. The image forming device 10 has a print function of receiving various data via the communication line (not shown) and performing image forming processing based on the received data, a copying function of taking a copy of an image recorded on a document onto a recording paper, and a facsimile function of performing transmission and reception of various data via the telephone line 80.

The image forming device 10 has a document reading unit 12 provided at an upper part thereof and an image forming unit 14 provided under the document reading unit 12. The document reading unit 12 has a document conveying unit 18 in a document cover 16. The document conveying unit 18 draws documents 20 mounted on a document feeder 16A provided in the document cover 16 sequentially and conveys the documents 20 onto a platen glass (not shown), and reads an image recorded on each of the documents 20. The document conveying unit 18 discharges each document 20, of which the image reading is finished, to a document discharge unit 16B provided on the document cover 16.

The document reading unit 12 is provided with a user interface 22 that receives various instruction operations by the user. The user interface 22 has a touch panel type display 24 on which display buttons for realizing reception of the instruction operations by the software program and various information are displayed, a hardware key 26 such as a numeric pad and a start button, and the like. The user interface 22, with the hardware key 26 and/or display buttons of the display 24, is used as a dial key of a telephone when the facsimile function is used, or used for setting magnifications and number of copies when the copying function is used.

Meanwhile, the image forming unit 14 has a paper storage unit 28 for storing recording paper sheets as recording media for image forming. The image forming unit 14 takes out recording paper sheets stored in the paper storage unit 28 one by one and forms an image based on image data on the recording paper sheet by the electrophotographic process, for example. Further, the image forming unit 14 discharges the recording paper sheet, on which the image forming is finished, sequentially onto a discharge unit (not shown).

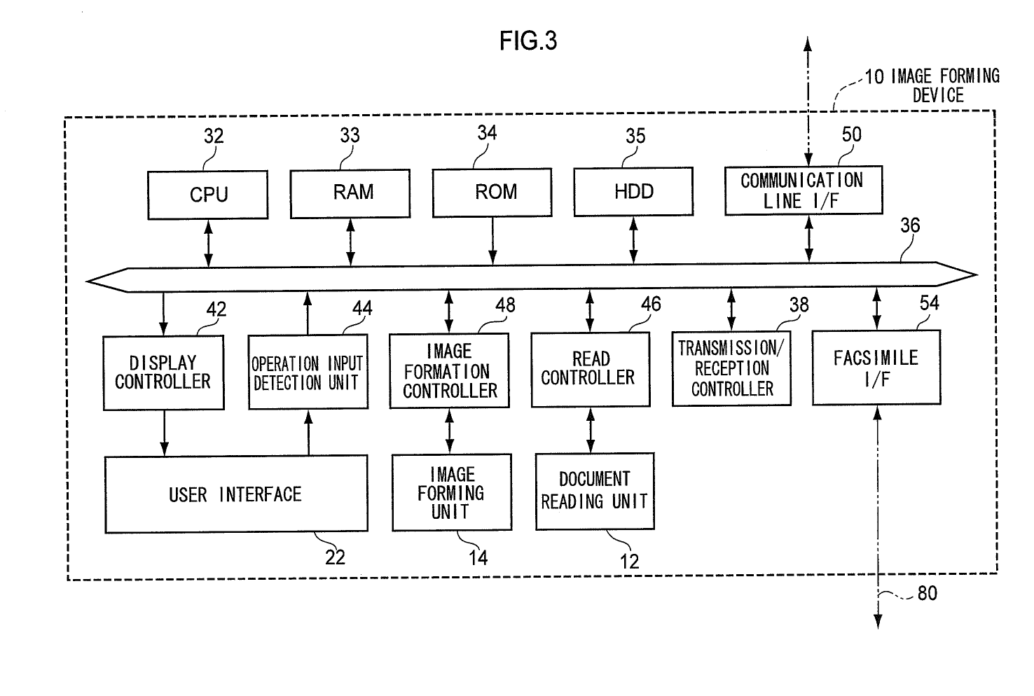

FIG. 3 illustrates the structure of a principal part of the electric system of the image forming device 10.

As illustrated in FIG. 3, the image forming device 10 has a Central Processing Unit (CPU) 32 that controls the operation of the whole device, a Random Access memory (RAM) 33 that stores various data temporarily, a Read Only Memory (ROM) 34 that stores various programs including control programs for the whole device, and an Hard Disk Drive (HDD) 35 that functions as a storage device that stores various data, application programs and the like. These components are electrically connected via a bus 36 such as a system bus and constitutes a computer having a typical structure.

On the other hand, the image forming device 10 includes a display controller 42 which is connected to the user interface 22 and controls display of various operation screens and the like on the display 24 of the user interface 22, and an operation input detection unit 44 which is connected to the user interface 22 and detects an operation instruction input via the user interface 22. These components are connected electrically via the bus 36.

Further, the image forming device 10 has a read controller 46 that controls an optical image reading operation by the document reading unit 12 and a document transfer operation by the document conveying unit 18, and an image formation controller 48 that controls image forming processing by the image forming unit 14. Furthermore, the image forming device 10 has a communication line interface (communication line I/F) 50 which is connected to a communication line (not shown) and performs transmission and reception of communication data with another external device connected to the communication line, a facsimile interface (facsimile I/F) 54 which is connected to the telephone line 80 and performs transmission and reception of facsimile data with a facsimile device connected to the telephone line 80, and a transmission/reception controller 38 that controls transmission and reception of facsimile data via the facsimile interface 54. The transmission/reception controller 38, the read controller 46, the image formation controller 48, the communication line interface 50, and the facsimile interface 54 are also electrically connected to each other via the bus 36.

Due to this structure, the CPU 32 may perform access to the RAM 33, ROM 34 and HDD 35 respectively, display control of various information such as messages and operation screens on the display 24 of the user interface 22 via the display controller 42, operation controls of the document conveying unit 18 and the document reading unit 12 via the read controller 46, operation control of the image forming unit 14 via the image forming controller 48, transmission and reception control of communication data via the communication line interface 50, and transmission and reception control of facsimile data via the facsimile interface 54 by the transmission/reception controller 38. Further, the CPU 32 understands the operations at the user interface 22 based on operation information detected by the operation input detection unit 44 and performs various controls based on these operations.

In the image forming device 10, when selection of the facsimile function (facsimile transmission) is detected on the user interface 22, the transmission/reception controller 38 executes facsimile transmission. When a user performs facsimile transmission using the image forming device 10, the user places a document 20 on the document feeder 16A and specifies a telephone number of the facsimile device which is the destination (hereinafter referred to as “destination information”) at the user interface 22. This destination information may be input directly using the numeric pad, or the telephone number may be stored in advance in association with destination name in the storage device such as the HDD 35.

When an operation of the start button provided as the hardware key 26 on the user interface 22 is detected, the document reading unit 12 is activated and starts reading of an image of the documents 20 placed on the document feeder 16A. When image reading of all the documents 20 is finished, the obtained image data is transferred to the facsimile interface 54 via the transmission/reception controller 38. The transmission/reception controller 38 uses the facsimile interface 54 to establish connection to the specified destination facsimile via the telephone line 80, and transmits the image data as facsimile data to the facsimile device.

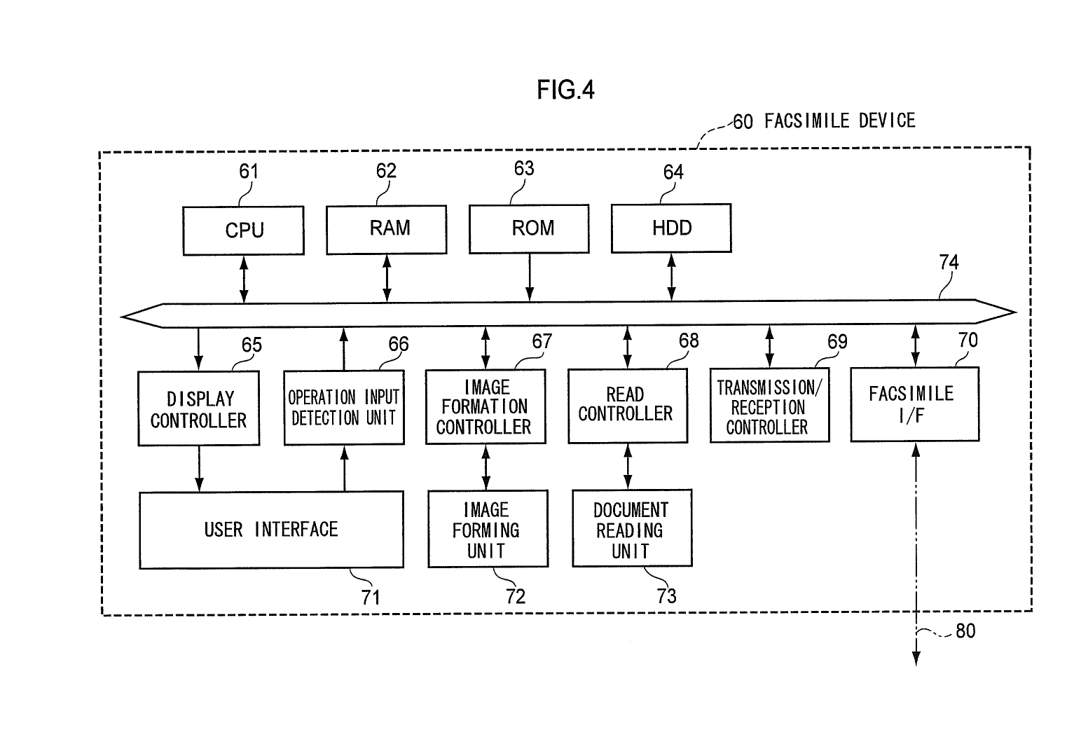

FIG. 4 illustrates the main structure of the electric system the facsimile device 60. As illustrated in FIG. 4, the structure of the facsimile device 60 has almost the same structure as that of the image forming device 10 except that the communication line interface 50 is not provided in the facsimile device 60.

That is, the facsimile device 60 has a CPU 61 that controls the operation of the whole device, a RAM 62 that stores various data temporarily, a ROM 63 that stores various programs including control programs for the whole device, and an HDD 64 that stores various data and programs. These components are electrically connected via a bus 74 such as a system bus and constitute a computer having a typical structure.

The facsimile device 60 also has a user interface 71, an image forming unit 72 and a document reading unit 73, each serving the same role as the components of the image forming device 10 indicated with similar names. Further, the facsimile device 60 has a display controller 65 which is connected to the user interface 71 and controls display of various operation screens or the like on the display of the user interface 71, and an operation input detection unit 66 which is connected to the user interface 71 and detects operation instructions input via the user interface 71. These components are also electrically connected via the bus 74.

In addition, the facsimile device 60 has a read controller 68 that controls a document feed operation by a document transfer unit (not shown) and an optical image reading operation by the document reading unit 73, and an image formation controller 67 that controls image forming processing by the image forming unit 72. Furthermore, the facsimile device 60 has a facsimile interface (facsimile I/F) 70 which is connected to the telephone line 80 and performs transmission and reception of facsimile data with various devices connected to the telephone line 80, and a transmission/reception controller 69 that controls transmission and reception of facsimile data via the facsimile interface 70. The transmission/reception controller 69, the read controller 68, the image formation controller 67 and the facsimile interface 70 are electrically connected to each other via a bus 74.

Due to this structure, the CPU 61 may perform access to the RAM 62, the ROM 63 and the HDD 64, display control of various information such as messages and operation screens on the display of the user interface 71 via the display controller 65, operation control of the document transfer unit and the document reading unit 73 via the read controller 68, operation control of the image forming unit 72 via the image formation controller 67, and control of transmission and reception of facsimile data via the facsimile interface 70 by the transmission/reception controller 69. Further, the CPU 61 understands the operations at the user interface 71 based on the operation information detected by the operation input detection unit 66 and performs various controls based on the operations.

In the facsimile device 60, when facsimile transmission is selected at the user interface 71, the transmission/reception controller 69 performs facsimile transmission. When a user performs facsimile transmission using the facsimile device 60, the user places documents on a document feeder (not shown) and specifies a telephone number of a destination facsimile device using the user interface 71.

When operation of the start button provided as a hardware key on the user interface 71 is detected, the document reading unit 73 is activated and starts reading of images of the documents on the document feeder. When reading of the images of all of the documents is finished, the obtained image data is transferred via the transmission/reception controller 69 to the facsimile interface 70. The transmission/reception controller 69 uses the facsimile interface 70 to connect to the specified destination facsimile device via the telephone line 80 and transmits the image data as facsimile data to the facsimile device.

On the other hand, when a selection of use of the above-described image transmission service is detected at the user interface 71, a call is issued to the image forming device 10. In response to this call, the image forming device 10 establishes a communication with the facsimile device 60 and obtains a telephone number of the source facsimile device 60 as first destination information. In the image forming device 10, the first destination information is obtained using a caller number identification function.

The user of the image forming device 10 places a document to be transmitted (hereinafter, “offer document”) on the document feeder 16A of the source facsimile device 60, and presses the start button. In response, the image forming device 10 reads an image of the offer document and obtains second destination information indicating a destination of the offer document from the obtained image data (hereinafter, “offer document image data”). Only when the destination indicated by the second destination information and the destination indicated by the first destination information match, the offer document image data is transmitted to the facsimile device 60 as the destination, i.e., the source facsimile device 60.

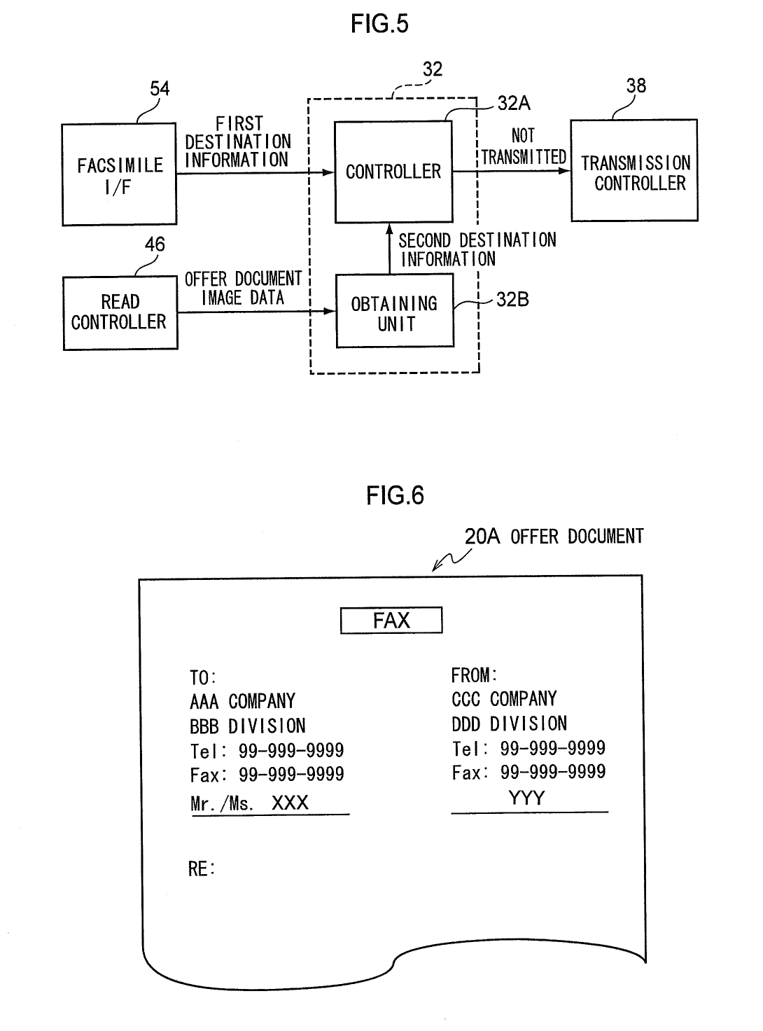

FIG. 5 is a functional block diagram illustrating the functional scheme of the image transmission service which is performed by the image forming device 10.

As illustrated in FIG. 5, the CPU 32 of the image forming device 10 has a controller 32A and an obtaining unit 32B. The controller 32A obtains the first destination information received from the source facsimile device 60 via the facsimile interface 54. The obtaining unit 32B obtains the second destination information indicating a destination of the offer document image data based on the offer document image data obtained via the read controller 46.

FIG. 6 illustrates an example of the offer document according to the exemplary embodiments.

As illustrated in FIG. 6, a destination facsimile number (telephone number) is described in the offer document 20A. The obtaining unit 32B obtains the second destination information from the offer document image data obtained by the read controller 46 by converting the image of the facsimile number into text data using the character recognition technique. Here, since converting the image of the facsimile number into text data using the character recognition technique is known, further explanation thereof will be omitted.

The controller 32A does not perform facsimile transmission via the transmission/reception controller 38 when the destination indicated by the first destination information obtained via the facsimile interface 54 is different from the destination indicated by the second destination information obtained by the obtaining unit 32B.

The processing performed by each components of the thus structured image forming device 10 may be realized by a software using a computer executing a program. However, embodiments are not limited to be realized by a software configuration, and may be realized by a hardware configuration or a combination of a hardware configuration and a software configuration.

In the following description, an explanation will be given of a case in which the image forming device 10 realizes the processing of each of the components by execution of the program. In this case, an embodiment in which the program is pre-installed in the image forming device 10, an embodiment in which the program is stored in a computer readable storing medium and provided, an embodiment in which the program is distributed via wired or wireless communication means, and the like are possible.

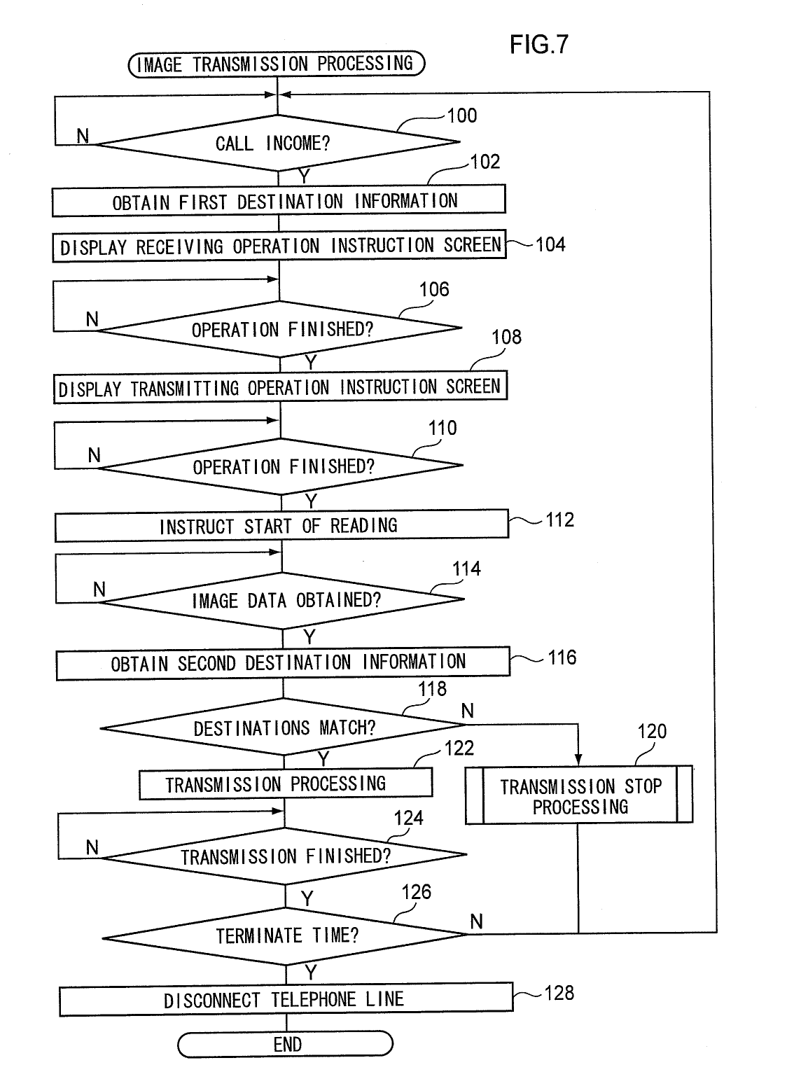

Next, with reference to FIG. 7, an operation of a communication system 98 according to the exemplary embodiments when executing the image transmission service will be described. FIG. 7 is a flowchart illustrating a flow of the image transmission program executed by the CPU 32 of the image forming device 10. The program is stored in advance in the HDD 35. In order to avoid complication, an explanation will be given here of a case in which only one type of offer document is provided for each of the facsimile device 60. Further, the explanation will be given of the case in which the image forming device 10 is set to a manual reception mode.

In step 100 of FIG. 7, the image forming device 10 waits for a call from any of the facsimile devices 60. In step 102, the image forming device 10 uses the caller number identification function and obtains the first destination information (telephone number) corresponding to the source facsimile device 60.

In step 104, the display controller 42 is controlled to display a predetermined receiving operation instruction screen on the display 24 of the user interface 22, and in step 106, the image forming device 10 waits until a predetermined operation is finished.

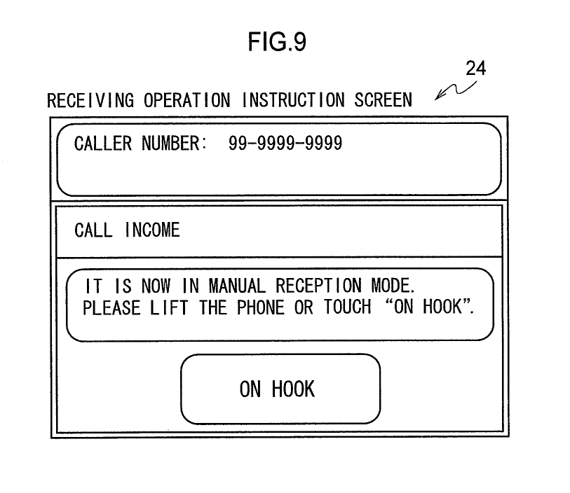

FIG. 9 illustrates an example of the receiving operation instruction screen displayed on the display 24 due to the processing of step 104. As illustrated in FIG. 9, the first destination information obtained in step 102 is displayed as the caller number on the receiving operation instruction screen, and in order to establish the communication, a message “It is now in manual reception mode. Please lift the phone or touch “on hook”.” together with a display of “on hook” button. When the receiving operation instruction screen as shown in FIG. 9 is displayed on the display 24, the user may lift the phone (not shown) or touch the “on hook” button displayed on the receiving operation instruction screen. In response to this operation, a positive determination is made in step 106, and the processing proceeds to step 108.

In step 108, the display controller 42 is controlled to display a predetermined transmitting operation instruction screen on the display 24 and waits until a predetermined operation is finished in step 110.

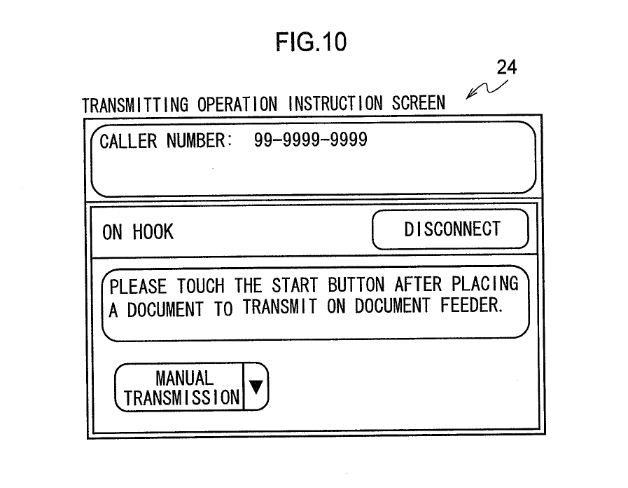

FIG. 10 illustrates an example of the transmitting operation instruction screen displayed on the display 24 due to the processing of step 108. As illustrated in FIG. 10, in the transmitting operation instruction screen according to this exemplary embodiment, the caller number is continued to be displayed and a message “Please touch the start button after placing a document to be transmitted on the document feeder”, is displayed. When the transmitting operation instruction screen shown in FIG. 10 is displayed on the display 24, the user may place the offer document to be transmitted on the document feeder 16A and touch the start button on the user interface 22. In response to this operation, a positive determination is made in step 110 and the processing proceeds to step 112.

In step 112, the image forming device 10 instructs the read controller 46 to execute the reading operation. In response to this instruction, the read controller 46 controls the document reading unit 12 so as to execute reading of an image of the offer document on the document feeder 16A, and transmits the obtained image data as the offer document image data to the CPU 32.

In step 114, the image forming device 10 waits until the offer document image data is received at the CPU 32 and in step 116, the received offer document image data is used to obtain the second destination information indicating a destination of the offer document using the known character recognition technique.

In step 118, it is determined whether or not the destination indicated by the first destination information obtained in the processing of step 102 and the destination indicated by the second destination information obtained in the processing of step 116 match. When a positive determination is made, the processing proceeds to step 122, in which the image forming device 10 instructs the transmission/reception controller 38 to transmit the offer document image data to the destination indicated by the second destination information. In response to this operation, the transmission/reception controller 38 executes transmission of the offer document image data to the destination.

In step 124, the image forming device 10 waits until the transmission of the offer document image data to the destination by the transmission/reception controller 38 is finished, and the process proceeds to step 126 which will be described later.

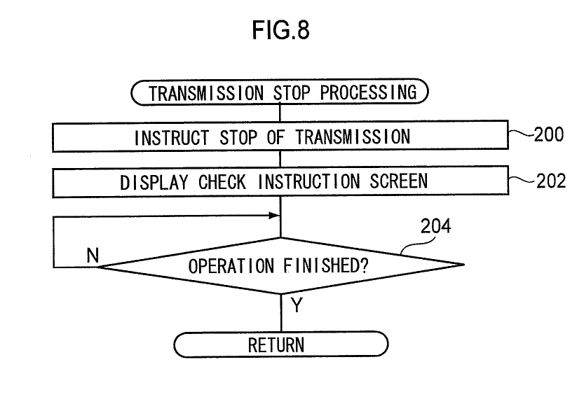

If a negative determination is made in step 118, the process proceeds to the step 120 and the transmission stop routine program is executed. An explanation will be given with reference to FIG. 8, regarding the transmission stop routine program according to the present exemplary embodiment.

In step 200 of FIG. 8, the image forming device 10 instructs the transmission/reception controller 38 to stop transmission of the offer document image data, and in step 202, controls the display controller 42 to display a predetermined check instruction screen on the display 24. In step 204, the image forming device 10 waits until a predetermined operation is finished.

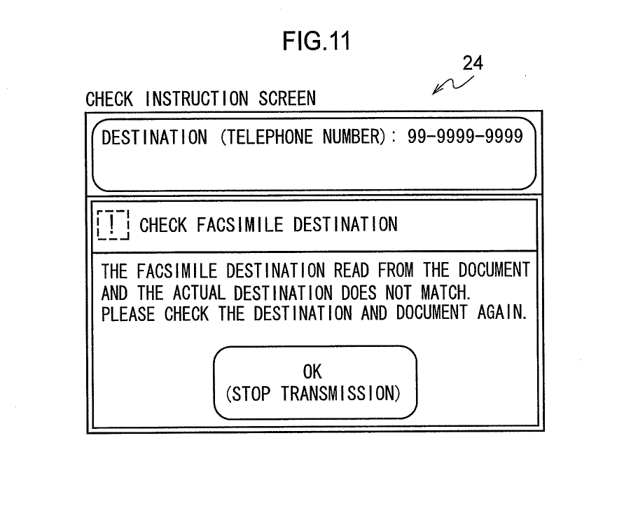

FIG. 11 illustrates an example of the check instruction screen displayed on the display 24 in step 202. As illustrated in FIG. 11, in the check instruction screen, the second destination information obtained by the processing of step 116 is displayed as “destination (telephone number)”, and a message “The facsimile destination read from the document does not match with the actual destination. Please check the destination and the document again.” and an “O.K. (stop transmission)” button are displayed. When the check instruction screen shown in FIG. 11 is displayed on the display 24, the user may check whether or not the destination displayed in the check instruction screen and/or the offer document on the document feeder 16A are correct and touch the “O.K. (stop transmission)” button displayed on the check instruction screen. In response to this operation, a positive determination is made in step 204 and the transmission stop routine program is terminated. Then, the processing returns to step 100 of the image transmission program (see FIG. 7).

In step 126, it is determined whether or not a predetermined time to terminate the image transmission program has arrived, and if a negative determination is made, the processing returns to step 100. On the other hand, when a positive determination is made, the processing proceeds to step 128, and disconnect the telephone line 80 and the image transmission program is finished. In the communication system 90 according to the present exemplary embodiment, the predetermined time is set to be a time when the user instructs to terminate the image transmission program using the user interface 22. However, embodiments are not limited to this, and the time may be a time when there occurs any error in the image forming device 10, an ending time of offering of the image transmission service, or any other time.

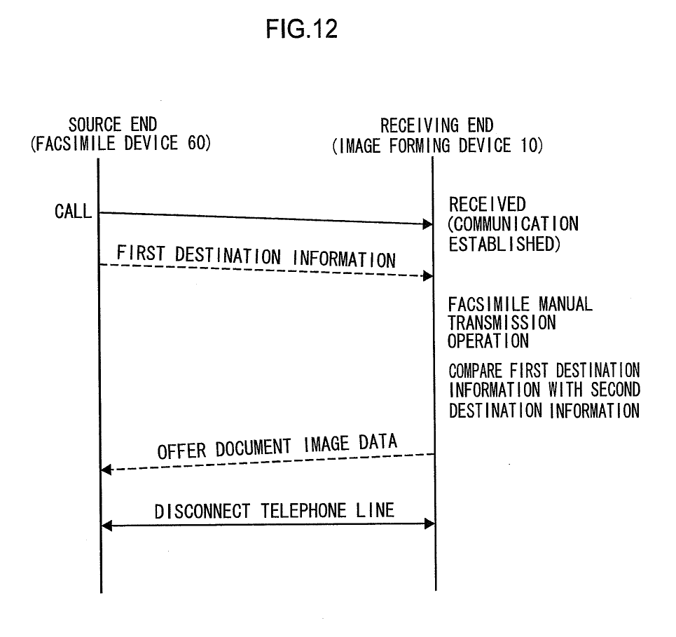

FIG. 12 illustrates a transition of the communication state between the source (the caller facsimile device 60) and the destination (the image forming device 10) during the execution of the image transmission service.

As illustrated in FIG. 12, when a call incomes from any facsimile device 60 to the image forming device 10 to execute the image transmission service, the image forming device 10 establishes a communication and obtains the first destination information from the source facsimile device 60.

Then, in the image forming device 10, the second destination information is obtained from the offer document image data obtained by reading the offer document, and the destination indicated by the first destination information and the destination indicated by the above-mentioned second destination information are compared. Only when the destination matches, the offer document image data is transmitted to the destination facsimile device 60 and after the transmission is finished, the telephone line 80 is disconnected.

### Second Exemplary Embodiment

The first exemplary embodiment has been described as an example in which, in the image transmission service, only one type of the offer document is transmitted to one facsimile device 60. In the second exemplary embodiment, plural types of offer documents are allowed for one facsimile device 60. Since the structure of the communication system 90 according to the second exemplary embodiment is the same as that of the first exemplary embodiment, explanation thereof will not be repeated here.

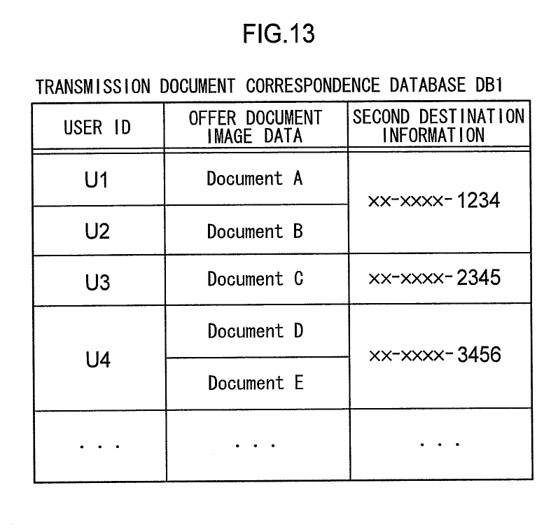

In the communication system 90 according to the second exemplary embodiment, the plural types of documents are accepted to be transmitted to one facsimile device 60. Therefore, the image forming device 10 according to the second exemplary embodiment has an authentication function of authenticating the user of the image forming device 10, and a transmission document correspondence database DB1 as shown in FIG. 13 as an example is stored in the HDD 35 of the image forming device 10.

As the above authentication function, a method is employed in which causing a user who is permitted to use the image forming device 10 to specify a user ID (Identification), which is assigned in advance to the user, by using the numeric pad of the user interface 22, and authenticating the user to be an authorized user if the specified user ID is included in user IDs which is pre-registered in the image forming device 10. In the image forming device 10, as illustrated in FIG. 13, the transmission document correspondence database DB1 is provided in which the user ID, the offer document image data, and the second destination information are stored with association with each other.

The user ID in the transmission document corresponding database DB1 is the same information as the user ID assigned in advance to each user. The offer document image data is image data of an offer document which is pre-registered by the user assigned with the corresponding user ID to be transmitted to the facsimile device 60 in the image transmission service. The second destination information is information indicating a telephone number corresponding to a destination facsimile device 60 of the offer document image data.

In the example illustrated in FIG. 13, the offer document image data registered by the user assigned with the user ID “U1” is image data representing a document A, and the offer document image data is specified to be transmitted to the facsimile device 60 of the telephone (facsimile) number “xx-xxxx-1234”.

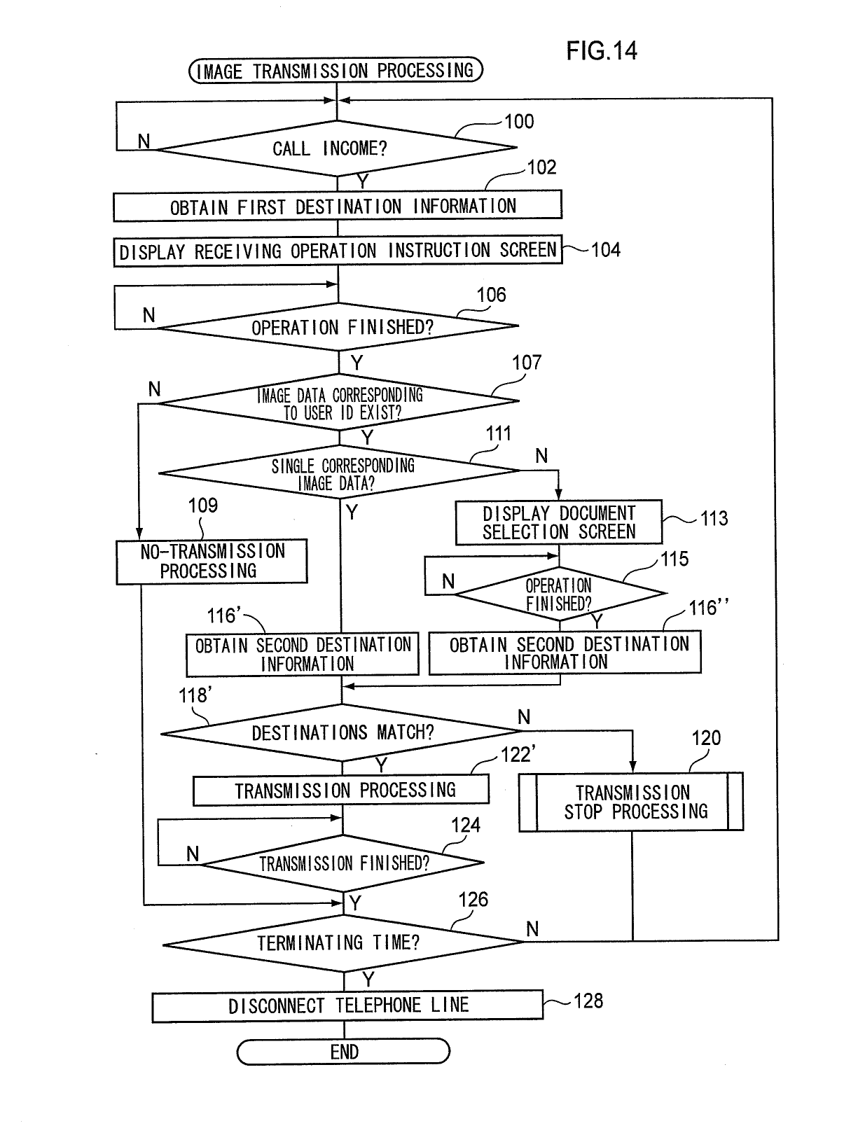

Next, an explanation will be given with reference to FIG. 14 of the operation of the communication system 90 according to the second exemplary embodiment when executing the image transmission service. FIG. 14 is a flowchart illustrating the flow of the image transmission program executed by the CPU 32 of the image forming device 10 according to the second exemplary embodiment. The steps in FIG. 14 which perform the same processing as in FIG. 7 are denoted by similar step numbers and explanation thereof is omitted to be minimal. Further, in order to avoid complication, the explanation is given for a case in which the user of the image forming device 10 is already authenticated as an authorized user and the transmission document correspondence database DB1 is already established.

In step 107 of FIG. 14, it is determined whether or not the offer document image data corresponding to the user ID of the authorized user (hereinafter referred to as “authorized user ID”) is registered in the transmission document correspondence database DB1. When a negative determination is made, the processing proceeds to step 109 and no-transmission processing is executed. Then, the processing proceeds to step 126. In the communication system 90, the no-transmission processing is to control the display controller 42 so as to display on the display 24 of the user interface 22 a message notifying that the offer document image data to be transmitted is not registered.

Meanwhile, when a positive determination is made in step 107, the processing proceeds to step 111 and it is determined whether or not the number of set of the offer document image data corresponding to the authorized user ID registered in the transmission document correspondence database DB1 is one. When a positive determination is made, the processing proceeds to step 116′, in which the second destination information corresponding to the authorized user ID is read-out from the transmission document correspondence database DB1, and then, the processing proceeds to step 118′. When a negative determination is made, the processing proceeds to step 113.

In step 113, the image forming device 10 controls the display controller 42 so as to display a predetermined document selection screen on the display 24 of the user interface 22. In the next step 115, the image forming device 10 waits until a predetermined operation is finished.

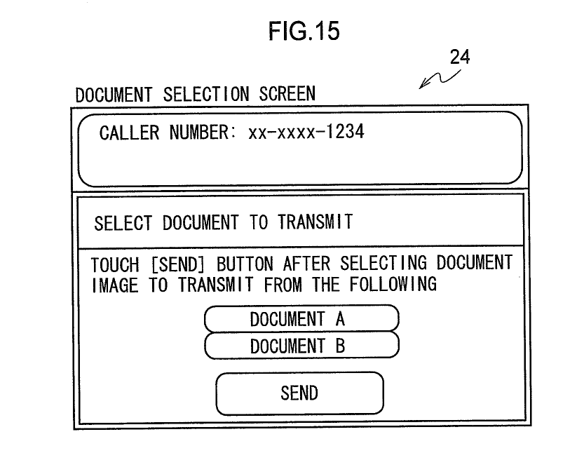

FIG. 15 illustrates an example of the document selection screen displayed on the display 24 in step 113. As illustrated in FIG. 15, in the document selection screen, the first destination information obtained in step 102 is displayed as the caller number. Further, a message “Touch the “send” button after selecting document image to be transmitted from the following” together with plural buttons representing plural sets of offer document image data corresponding to the authorized user ID (in the example of FIG. 15, two buttons “Document A” and “Document B”) and a “send” button are displayed. When the document selection screen as shown in FIG. 15 is displayed on the display 24, the user may touch a button corresponding to the offer document to be transmitted, with reference to the caller number or the like displayed on the document selection screen, and then, may touch the “send” button. In response to this operation, a positive determination is made in step 115, and the processing proceeds to step 116″.

In step 116″, the second destination information corresponding to the offer document specified at the document selection screen by the user is read-out from the transmission document correspondence database DB1, and then, the processing proceeds to step 118′.

In step 118′, it is determined whether or not the destination indicated by the first destination information obtained in step 102 and the destination indicated by the second destination information obtained in step 116′ or 116″ match. When a negative determination is made, the processing proceeds to step 120. When a positive determination is made, the processing proceeds to step 122′ and the offer document image data corresponding to the second destination information obtained in step 116′ or 116″ and the authorized user ID is read-out from the transmission document correspondence database DB1, and the transmission/reception controller 38 is instructed to transmit the read offer document image data to the destination indicated by the second destination information. In response to this operation, the transmission/reception controller 38 performs transmission of the read offer document image data to the destination.

### Third Exemplary Embodiment

The first exemplary embodiment has been described as the example in which when the destination indicated by the first destination information and the destination indicated by the second destination information in the image transmission service are different from each other, the offer document image data is not transmitted. The third exemplary embodiment will be described as an example in which the destination of the offer document image data is confirmed with a user. The structure of the communication system 90 according to the third exemplary embodiment is the same as that of the first exemplary embodiment and, therefore, the explanation thereof is omitted.

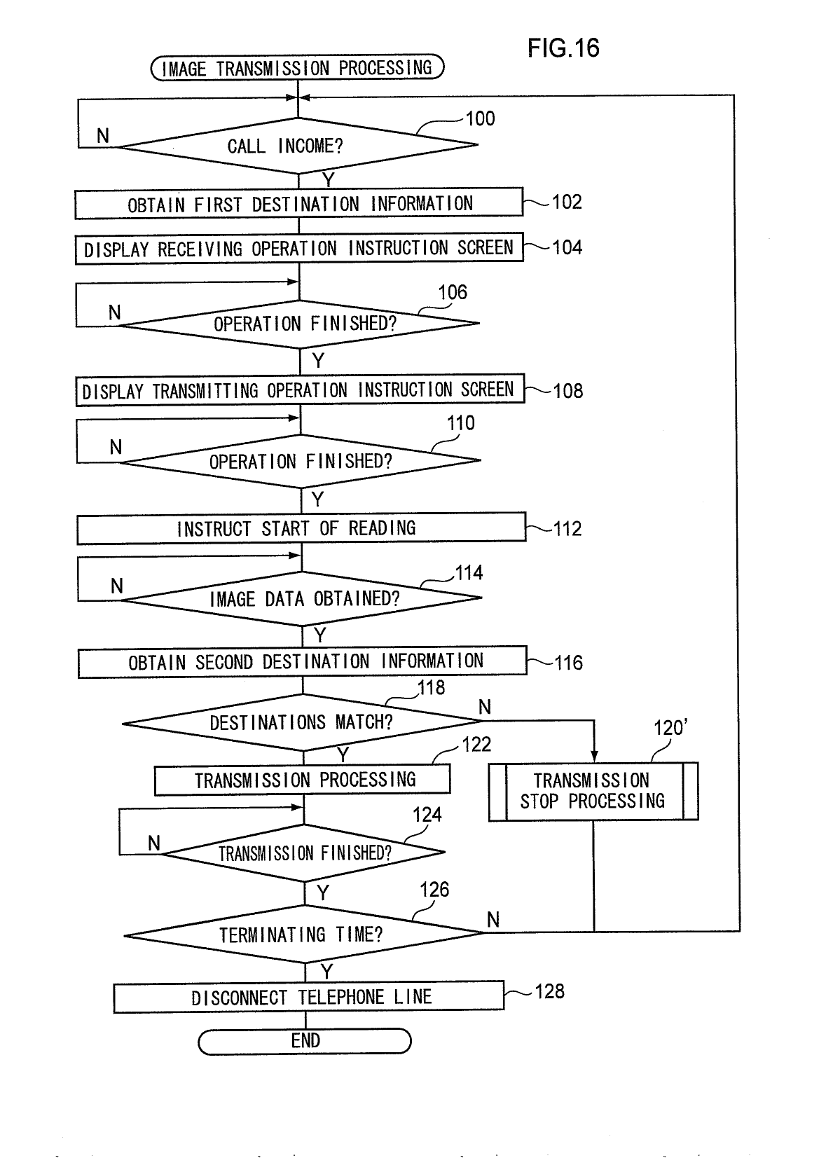

Firstly, an explanation will be given with reference to FIG. 16 of the operation of the communication system 90 according to the third exemplary embodiment when executing the image transmission service. FIG. 16 is a flowchart illustrating the processing of the image transmission program executed by the CPU 32 of the image forming device 10 according to the third exemplary embodiment. Steps in FIG. 16 that execute the same processing as those in FIG. 7 are denoted by similar step numbers and explanation thereof is omitted. In order to avoid complication, the explanation will be given for a case in which the type of the offer document only one for a facsimile device 60, and the image forming device 10 is set in the manual reception mode.

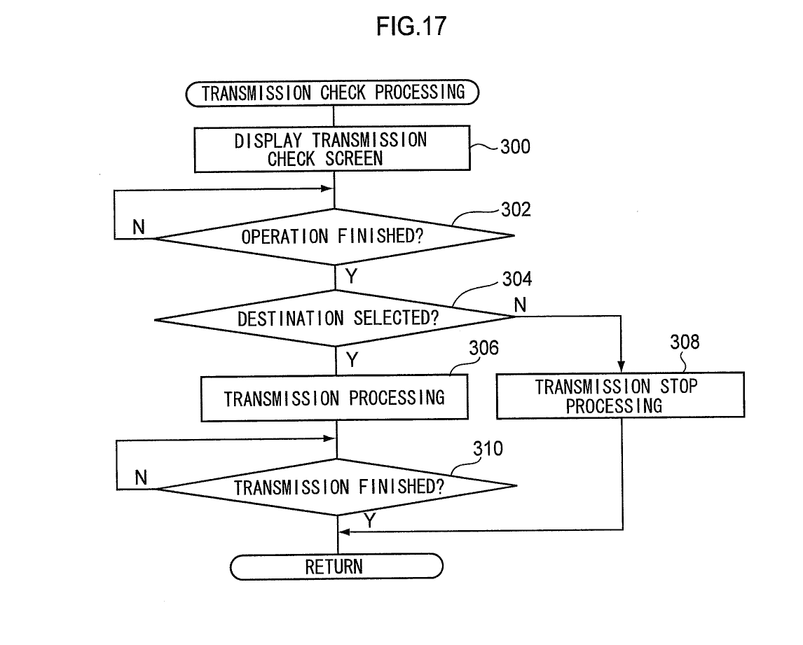

In step 120′ of FIG. 16, a transmission check routine program is executed. The description on the transmission check routine program according to the third exemplary embodiment is given below with reference to FIG. 17.

In step 300 of FIG. 17, the image forming device 10 controls the display controller 42 so as to display a predetermined transmission check (confirmation) screen on the display 24. In next step 302, the image forming device 10 waits until a predetermined operation is finished.

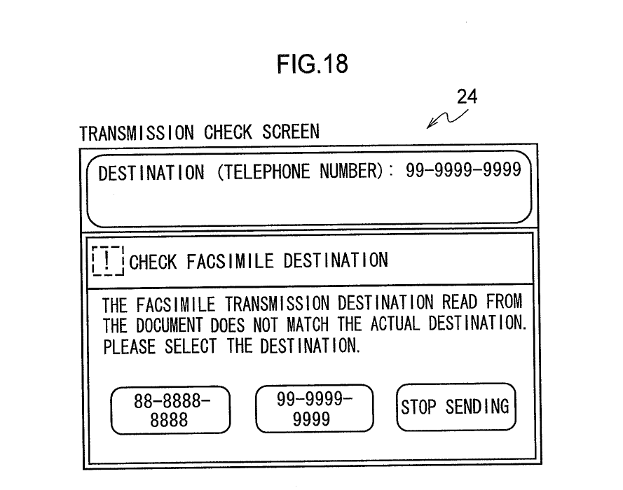

FIG. 18 illustrates an example of the transmission check screen displayed on the display 24 in step 300. As illustrated in FIG. 18, in the transmission check screen according to the third exemplary embodiment, the second destination information obtained in step 116 is displayed as “communication destination (telephone number)”, while a message “The facsimile transmission destination read from the document does not match the actual communication destination. Please select the destination”, together with two buttons respectively indicate the first destination information and the second destination information (in this embodiment, “88-8888-8888” button and “99-9999-9999” button) and a “stop sending” button, are displayed. When the transmission check screen as illustrated in FIG. 18 is displayed on the display 24, the user may touch the button of the first destination information when the offer document image data should be transmitted to the destination indicated by the first destination information, or the button of the second destination information when the transmission document image data should be transmitted to the destination indicated by the second destination information, or the “stop sending” button when the transmission document image data should not be sent. In response to this operation, a positive determination is made in step 302, and the processing proceeds to step 304.

In the step 304, it is determined whether or not either of the above-mentioned two buttons is touched in order to determine whether or not either of the destination indicated by the first destination information or the destination indicated by the second destination information is selected. When a positive determination is made, the processing proceeds to step 306 and the image forming device 10 instructs the transmission/reception controller 38 to transmit the offer document image data to the destination selected by the user. In response to this operation, the transmission/reception controller 38 performs transmission of the offer document image data to the selected destination.

In next step 310, the image forming device 10 waits until the transmission of the offer document image data to the destination by the transmission/reception controller 38 is finished, and then, the transmission check routine program is finished.

However, when a negative determination is made in step 304, the processing proceeds to step 308 and the image forming device 10 instructs the transmission/reception controller 38 to stop transmission of the transmission document image data, and then, the transmission check routine program is finished.

The present invention has been described above by way of the exemplary embodiments; however, the scope of the present invention is not limited to the scope described in the above-mentioned embodiments. Various modifications and improvements may be applied to the above-described exemplary embodiments without departing from the scope of the invention, and such modified or improved embodiments shall fall within the technical scope of the invention.

In addition, the exemplary embodiments are not intended to limit the invention recited in the claims, and all of combinations of the features and characteristics described in the embodiments are not necessarily indispensable in the elements of the invention. The exemplary embodiments contain various aspects of the invention and various inventions can be extracted in combination of any of disclosed elements. Even if any elements are deleted from the whole elements described in the exemplary embodiments, this structure may be regarded as the present invention as far as the same effect can be achieved.

For example, the exemplary embodiments have been described as examples in which the image transmission service is realized by the software configuration. However, the present invention is not limited thereto. For example, the image transmission service may be realized using a hardware configuration. In such case, for example, a functional device performing the same processing as the components (controller 32A and obtaining unit 32B) of the image forming device 10 illustrated in FIG. 5 may be provided. In this case, as compared with the above-described exemplary embodiments, processing speed of the image transmitting processing in the image transmission service is expected to be improved.

In addition, the exemplary embodiments have been described as the examples in which the first destination information is obtained using the caller number identification function. However, embodiments are not limited thereto. For example, the first destination information may be obtained from a tone signal sent from the source facsimile device 60. In this case, a user of the facsimile device 60 specifies a use of the image transmission service and then, specifies a facsimile number (telephone number) corresponding to the facsimile device 60 by the tone signal via the user interface 71.

The first and third exemplary embodiments have been described as the examples in which when executing the image transmission service, the second destination information is obtained from the facsimile number indicated in the transmission document using the character recognition technique. However, embodiments are not limit thereto. For example, the second destination information may be obtained by an instruction operation via the user interface 22 by the user. In this case, the user places the offer document on the document feeder 16A and specifies the second destination information (telephone number) corresponding to the destination facsimile device 60 using the user interface 22. At this time, this second destination information may be input directly via the numeric pad provided as the hardware key 26 of the user interface 22, or the destination name and the telephone number may be stored in advance in the storage device such as the HDD 35.

Further, the first and third exemplary embodiments have been described as the examples in which when the image transmission service is executed, a facsimile number which is described in the transmission document is obtained as the second destination information. However, embodiments are not limit thereto. For example, at least one of a company name of a transmission destination (“AAA COMPANY” in FIG. 6), a division name (“BBB DIVISION” in FIG. 6) and an addressee name (“Mr./Ms. XXX” in FIG. 6) indicated in the offer document may be obtained as the second destination information by using the character recognition technique. In this case, conversion data for converting the first destination information to information of same type as of the second destination information in accordance with the type of the second destination information to be obtained may be stored in advance in a storage device such as the HDD 35, and after converting the first destination information using the conversion data, the destination indicated by the information obtained by the conversion may be compared with the destination indicated by the obtained second destination information.

The second exemplary embodiment has been described as the example in which the user authentication of the image forming device 10 is performed using a user ID input by the user via the numeric pad of the user interface 22. However, embodiments are not limit thereto. For example, the authentication may be performed using wireless communication with FeliCa® or the like.

Further, the second exemplary embodiment has been described as the example in which the information for identifying a user which registered the transmission document image data is a user ID. However, embodiments are not limited thereto. For example, as illustrated in FIG. 6, when information indicating a transmission source such as a company name (“CCC COMPANY” in FIG. 6), a division name (“DDD DIVISION” in FIG. 6), a transmitter name (“YYY” in FIG. 6) is indicated in the offer document, the user ID may be replaced with any of these set of information.

Furthermore, the second exemplary embodiment has been described as the example in which the authentication of the user at the image forming device 10 is performed before executing the image transmission program illustrated in FIG. 14. However, embodiments are not limited thereto. The authentication may be performed at any time as far as it is before using the authentication result.

The third exemplary embodiment has been described as the example in which when the destination indicated by the first destination information and the destination indicated by the second destination information are different from each other, the user selects either of these two destinations. However, embodiments are not limited thereto. For example, the destination to transmit the offer document image data may be directly input by the user using inputting means (reception means) such as the user interface 22.

The structure of the communication system 90 described in each of the exemplary embodiments (see FIGS. 1 to 5) is merely an example, and that any unnecessary part may be deleted or any part may be added without departing from the scope of the invention.

The data structure of the transmission document correspondence database explained in the second exemplary embodiment (see FIG. 13) is also an example and any modification may be made thereto without departing from the scope of the invention.

The structure of the offer document illustrated in each of the exemplary embodiments (see FIG. 6) is also an example, and the description included in the offer document may be changed without departing from the scope of the invention.

The structures of display images illustrated in the exemplary embodiments (see FIGS. 9 to 11 and FIGS. 15 and 18) are examples and may be modified without departing from the scope of the invention.

Furthermore, the flows of the image transmission program, the transmission stop routine program and the transmission check routine program explained in the exemplary embodiments (see FIGS. 7, 8, 14, 16 and 17) are also described as examples, and may be modified by deleting any unnecessary step, adding any new step, and changing the processing order without departing from the scope of the invention.

What is claimed is:

1. A facsimile device comprising:
a transmitting unit that, when receiving a transmission instruction of image data while a communication state is established with a first destination of the image data, transmits the image data to the first destination;
a receiving unit that receives, from the first destination, first destination information indicating the first destination;
an obtaining unit that obtains second destination information indicating a second destination of the image data from the image data; and
a controller that controls the transmitting unit so as not to transmit the image data when the first destination indicated by the first destination information and the second destination indicated by the second destination information are different from each other.

2. The facsimile device according to claim 1, wherein the controller controls the transmitting unit so as to transmit the image data when the first destination indicated by the first destination information matches the second destination indicated by the second destination information.

3. The facsimile device according to claim 1, further comprising a display unit,
wherein the controller controls the display unit to display a confirmation screen for confirming an actual destination of the image data when the first destination indicated by the first destination information and the second destination indicated by the second destination information are different from each other.

4. The facsimile device according to claim 3, further comprising a reception unit that receives input of a destination of the image data,
wherein the controller controls the transmitting unit to transmit the image data to the destination when the reception unit receives the input of the destination after display of the confirmation screen.

5. The facsimile device according to claim 1, further comprising a storage unit that stores the second destination information obtained by the obtaining unit in association with the image data to be transmitted to the second destination indicated by the second destination information,
wherein the controller controls the transmitting unit to transmit the image data associated with the second destination information when the first destination indicated by the first destination information matches the second destination indicated by the second destination information.

6. An image forming device comprising:
the facsimile device according to claim 1; and
an image forming unit that forms an image represented by the image data in the facsimile device.

7. A communication system comprising:
a first facsimile device that is the facsimile device according to claim 1; and
a second facsimile device comprising a second transmitting unit that transmits the first destination information to the first facsimile device and a second receiving unit that receives the image data transmitted from the first facsimile device.

8. A computer readable storage medium storing a program for a computer to execute data communication processing, the data communication processing comprising:
obtaining, from image data, second destination information indicating a second destination of the image data;
receiving, from a first destination, first destination information indicating the first destination; and
controlling so as not to transmit the image data when the first destination indicated by the first destination information and the second destination indicated by the second destination information are different from each other.

9. The computer readable storage medium according to claim 8, the processing further comprising transmitting the image data when the first destination indicated by the first destination information matches the second destination indicated by the second destination information.

10. The computer readable storage medium according to claim 8, the processing further comprising displaying a confirmation screen for confirming an actual destination of the image data when the first destination indicated by the first destination information and the second destination indicated by the second destination information are different from each other.

11. The computer readable storage medium according to claim 10, the processing further comprising:
receiving input of a destination of the image data, and
transmitting the image data to the destination when the input of the destination is received after the confirmation screen is displayed.

12. The computer readable storage medium according to claim 8, the processing further comprising storing the obtained second destination information in association with the image data to be transmitted to the second destination indicated by the second destination information.

13. A data communication method comprising:
obtaining, from image data, second destination information indicating a second destination of the image data;
receiving, from a first destination, first destination information indicating the first destination; and
controlling so as not to transmit the image data when the first destination indicated by the first destination information and the second destination indicated by the second destination information are different from each other.

14. The data communication method according to claim 13, further comprising transmitting the image data when the first destination indicated by the first destination information matches the second destination indicated by the second destination information.

15. The data communication method according to claim 13, further comprising displaying a confirmation screen for confirming an actual destination of the image data when the first destination indicated by the first destination information and the second destination indicated by the second destination information are different from each other.

16. The data communication method according to claim 15, further comprising:
receiving input of a destination of the image data, and
transmitting the image data to the destination when the input of the destination is received after the confirmation screen is displayed.

17. The data communication method according to claim 13, further comprising storing the obtained second destination information in association with the image data to be transmitted to the second destination indicated by the second destination information.
